(19) United States
(12) Patent Application Publication
(10) Pub. No.: US 2023/0085294 A1
(43) Pub. Date: Mar. 16, 2023

(54) FOLDING LANDING NET

(71) Applicant: Pure Fishing, Inc., Spirit Lake, IA (US)

(72) Inventor: Timothy S. Makos, Grafton, WI (US)

(21) Appl. No.: 17/930,776

(22) Filed: Sep. 9, 2022

Related U.S. Application Data
(60) Provisional application No. 63/243,015, filed on Sep. 10, 2021.

(51) Int. Cl. A01K 77/00

(52) U.S. Cl. CPC A01K 77/005

(57) ABSTRACT

The present disclosure generally relates to a folding landing net that can be folded into a stow position for compact storage. In general, the net comprises a handle, a slide lock, and hoop. The slide lock can be slid on the handle in order to rotate the hoop arms, thereby rotating the hoops, either upward into a stow position or outward into an open position.

### CROSS-REFERENCE TO RELATED APPLICATION

This application claims priority to U.S. Provisional Patent Application Ser. No. 63/243,015, filed on Sep. 10, 2021, the entire contents of which are incorporated herein by reference.

### FIELD OF THE INVENTION

The present disclosure relates to fishing nets. In particular, the present disclosure relates to folding fishing nets that can be easily folded or collapsed to reduce their footprint when stored.

### BACKGROUND OF THE INVENTION

Sport fishing has become increasingly popular in recent years. Anglers now have a variety of products, including specialized reels, rods, containers and the like, with which they must travel with and store during their fishing activities. Accordingly, the avid angler must store a number of products in a limited space. Fishing nets are known to be bulky and difficult to store in a boat, kayak, canoe, or other fishing location when not in use. The present disclosure seeks to address this issue by providing a fishing net that can be stored neatly and compactly.

### SUMMARY

Provided herein is a folding landing net generally comprising a yoke, a hoop, and a handle. The hoop can comprise first and second hoop portions that are able to pivot upward or downward to collapse the net and provide for easy and compact storage. The yoke includes a main body portion and a slide lock. Sliding the slide lock down the handle removes pivot pins of the first and second hoop portions from pivot pin channels located in the main body portion, thereby facilitating rotation of the first and second hoop portions into an upward or downward position.

The foregoing and other features of the present invention will be apparent from the detailed description that follows.

### BRIEF DESCRIPTION OF THE DRAWINGS

For a better understanding of the various embodiments of the present invention, reference may be made to the accompanying drawings in which:

FIG. 1 is perspective view of a folding landing net according to one embodiment of the present disclosure;

FIG. 2 is a perspective view of a yoke portion of the landing net of FIG. 1 in an open position;

FIG. 3 is a perspective view of the yoke portion of the landing net of FIGS. 1 and 2 in a stow position;

FIG. 4 is a front perspective view of the yoke portion of the landing net of FIG. 3 in a stow position;

FIG. 5 is bottom cross-section view of the yoke portion of the landing net of FIGS. 3 and 4 in a stow position;

FIG. 6 is a bottom cross-section view of the yoke portion of the landing net of FIG. 5 in an open position;

FIG. 7 is a perspective view of the pivot arms of the landing net of FIGS. 1 to 6; and

FIG. 8 is a bottom perspective view of the yoke portion of the landing net of FIGS. 1 to 7.

Corresponding reference characters indicate corresponding parts throughout the drawings.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE DRAWINGS

The invention will now be described with reference to the drawings, in which like reference numerals refer to like parts throughout. For purposes of clarity in illustrating the characteristics of the present invention, proportional relationships of the elements have not necessarily been maintained in the drawing figures.

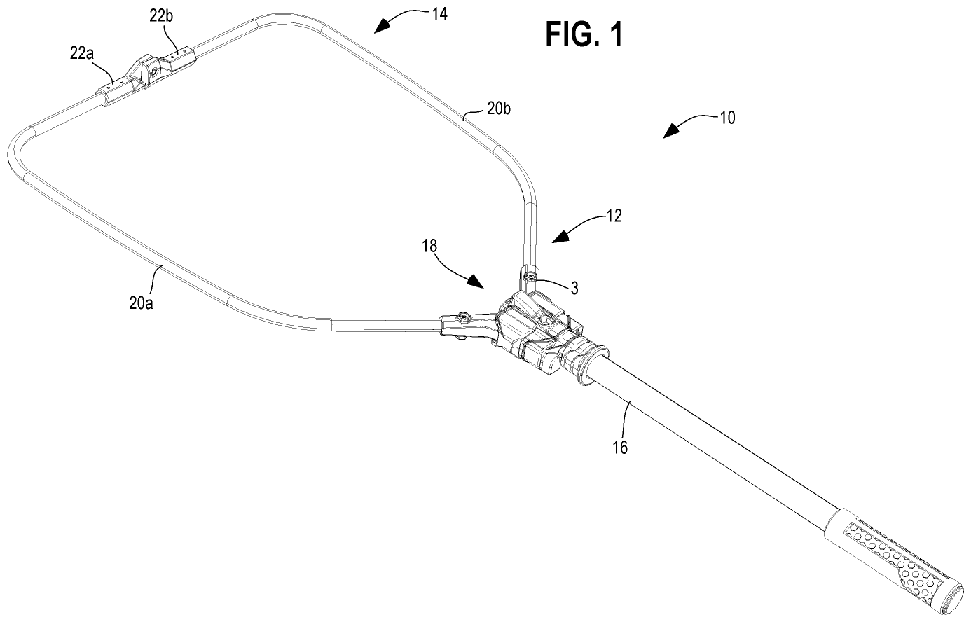

Referring now to FIG. 1, a landing net according to the present disclosure is generally indicated at reference numeral 10. The landing net 10 includes a yoke 12 and a hoop 14 as well as a handle 16 coupled thereto. The yoke 12 includes a main body 18 having an opening (not illustrated) into which the handle 16 slides into. The hoop 14 contains opposing hoop arms 20a, 20b coupled to one another via respective pivot arms 22a, 22b at distal ends thereof that are rotatable with respect to the yoke 12. In this way, when the arms 20a, 20b are rotated into an upward or downward position, the hoop 14 is collapsed into a stow position for easy and compact storage. Hoop arms 20a, 20b generally form one-half of the desired hoop shape. For example, when the hoop 14 is generally circular in shape, hoop arms 20a, 20b can be C-shaped or semi-circular shaped.

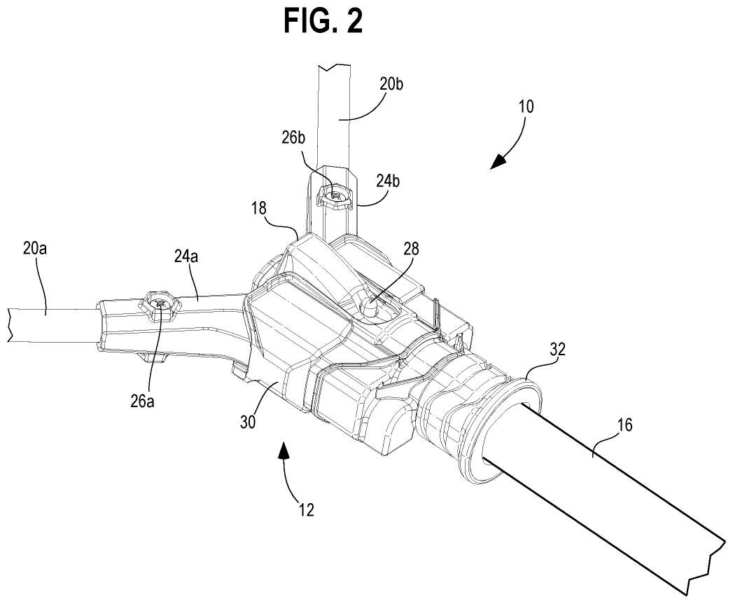

Turning now to FIG. 2, the hoop arms 20a, 20b are coupled to the yoke 12 at their proximal ends via hoop mounts 24a, 24b. In particular, the hoop mounts 24a, 24b define openings into which proximal ends of hoop arms 20a, 20b may slide. The hoop arms 24a, 24b are mounted into the hoop arms 20a, 20b via fasteners 26a, 26b (e.g., screws, nuts, bolts, or any other suitable fastener known in the art).

The handle 16 may be releasably mounted into the main body 18 using a snap button 28 that is positioned on the handle 16 and that snaps into a hole defined by the main body 18. In this way, when snap button 28 is depressed, the handle 16 can be removed from the main body 18.

A slide lock 30 can be positioned over the main body 18. The slide lock 30 is slidable with respect to the main body 18 and the handle 16. The slide lock 30 can thus be moved down the handle 16, and movement can be facilitated through gripping a lip 32 on the slide lock 30.

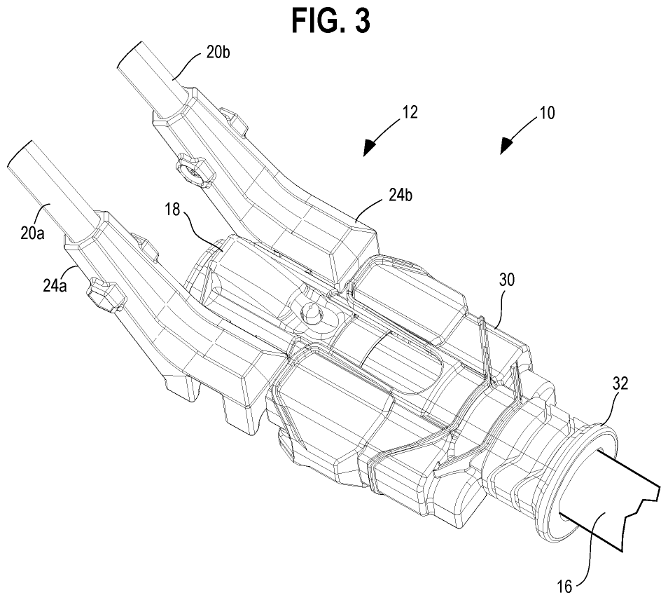

As can be seen in FIG. 3, sliding the slide lock 30 with respect to the main body 18 enables rotation of the hoop arms 20a, 20b upward or downward, as appropriate, into the stow position. Typically, the hoop arms 20a, 20b pivot about 90 degrees (for example, about 100 degrees), upward or downward into the stow position. When the slide lock 30 is slid toward the distal end of the handle 16, the hoop arms 20a, 20b pivot back out to form a horizontal plane and lock into an outward position.

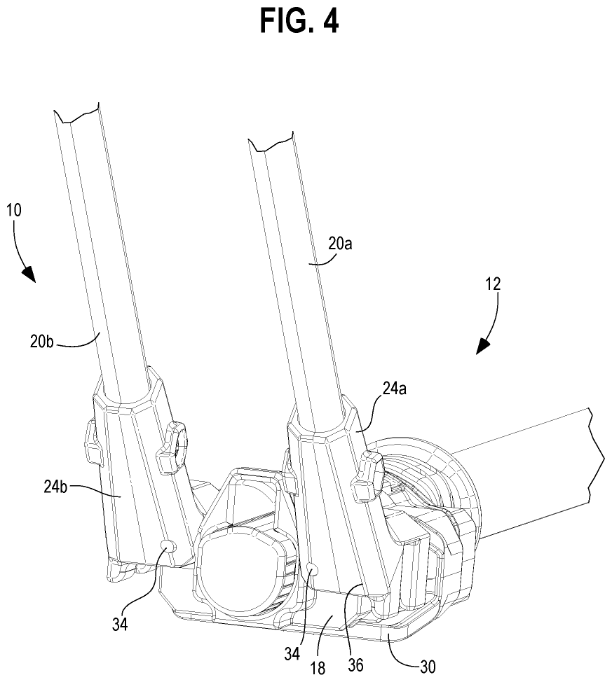

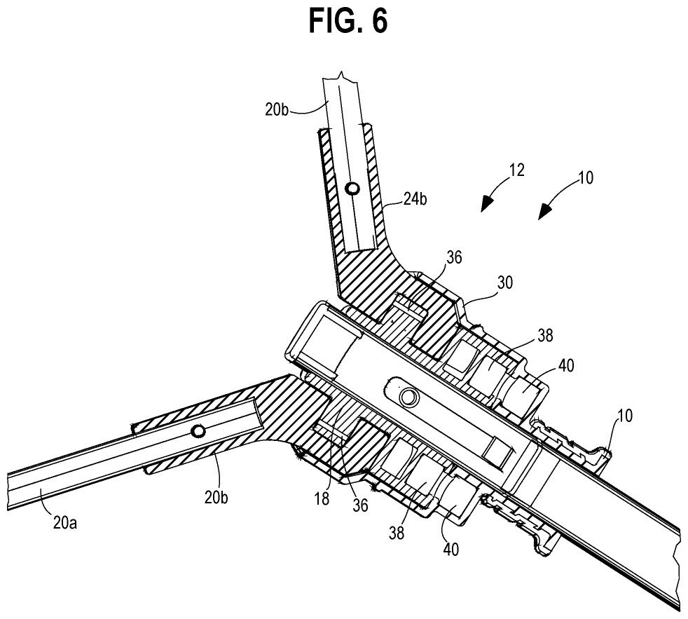

As provided in FIG. 4, rotation of the hoop arms 20a, 20b is facilitated by retraction of pivot pins 34. Pivot pins 34 are positioned in the hoop mounts 24a, 24b. When the slide lock 30 is slid distally down the handle 16, the pivot pins 34 are not able to engage pin channels 36 of the main body 18. Thus, the hoop arms 20a, 20b and respective hoop mounts 24a, 24b may be free to rotate. When the slide lock 30 is slid proximally up the handle 16, the pivot pins 34 engage and lock into pin channels 36 of the main body 18 and the hoop arms 20a, 20b are locked in an outward, horizontal position (see FIG. 6). Accordingly, in a first position, such as that illustrated in FIG. 4, the pins 34 can be received in the hoop mounts 24a, 24b and may not engage the pin channels 36. Because the hoops arms 20a, 20b are rotated upwards, the pins 34 may not be aligned with the pin channels 36. In a second position, such as that illustrated in FIG. 6, the main body 18 can be translated distally and in such a position that the pins 34 can be aligned with the pin channels 36 and can at least partially engage (e.g., at least partially be received within) the pin channels 36.

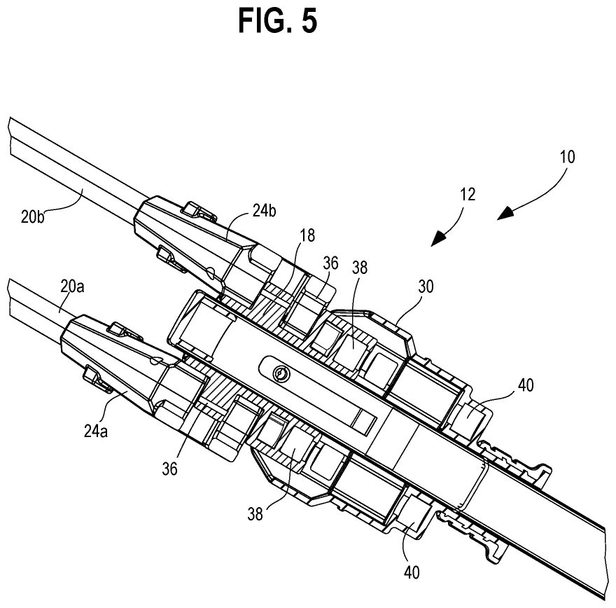

The main body 18 can include main body magnets 38 and the slide lock 30 can include slide lock magnets 40. The main body magnets 38 and the slide lock magnets 40 can be such that the main body magnets 38 attract the slide lock magnets 40 to secure the slide lock 30 into the open position, illustrated in FIG. 6. The hoop arms 20a, 20b can be rotated into the stow position of FIG. 5 by applying a force greater than the magnetic force between the main body magnets 38 and the slide lock magnets 40. Some embodiments may include only one of the main body magnets 38 or the slide lock magnets 40. In these embodiments, the magnet 38, 40 can be attracted to a ferro-magnetic material present in the main body 18 (when the main body magnets 38 are omitted) or the slide lock 30 (when the slide lock magnets 40 are omitted).

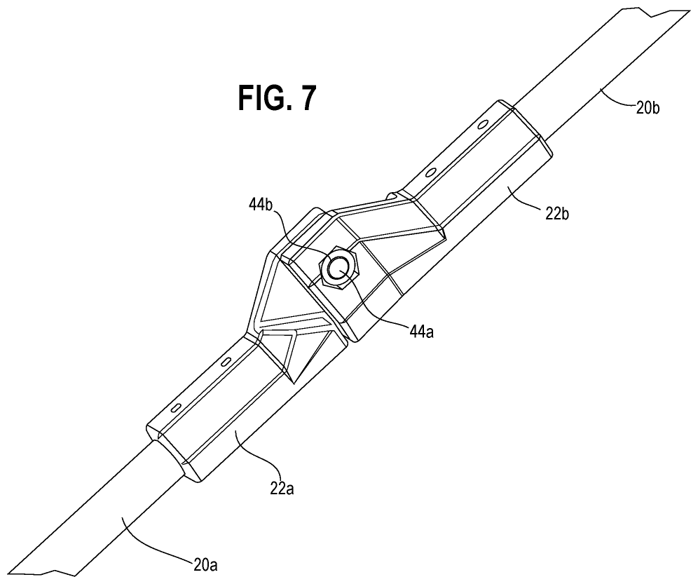

Turning now to FIG. 7, the distal end of hoop arms 20a, 20b are fastened to respective pivot arms 22a, 22b. The pivot arms 22a, 22b can be pivotably fastened together with fasteners 44a, 44b to form a pivot point when the landing net 10 is folded. Fasteners 44a, 44b can include, but are not limited to, screws, screws and nuts, bolts and nuts, and other similar fasteners known in the art.

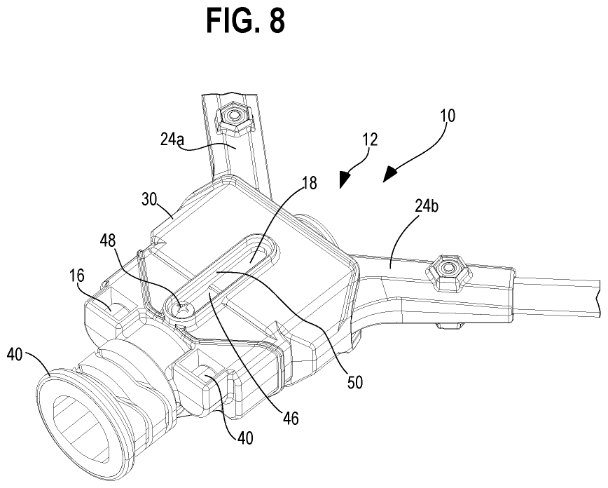

Referring now to FIG. 8, in some embodiments, the slide lock 30 can include a channel 46 that receives a fastener 48 for coupling the slide lock 30 to the main body 18. In some embodiments, the fastener 48 can engage with a lip 50 inside the channel 46 to allow the slide lock 30 to maneuver between the stow and open positions. In operation, when the slide lock 30 is moved between the stow position and the open position, the channel 46 can limit travel of the slide lock 30 when it is pulled by the lip 30 to the open position to prevent complete disengagement of the slide lock 30 from the main body 18.

In some embodiments, the landing net 10 can also include a lock mechanism (not shown) that secures the hoop arms 20a, 20b and the hoop mounts 24a, 24b in the stow position. Various embodiments for the lock mechanism are contemplated and can include, but are not limited to, additional magnets, a physical clamp or latch, and/or a friction fit snap connector. Furthermore, the lock mechanism can be attached to the hoop arms 20a, 20b at one or more locations such as embedded in the pivot arms 42a, 42b, the hoop mounts 24a, 24b, and/or other locations known to persons having skill in the art.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A folding landing net comprising:
a yoke;
a first hoop portion; and
a second hoop portion;
wherein the first hoop portion and the second hoop portion are pivotable with respect to the yoke such that in a first, open position, the first hoop portion generally opposes the second hoop portion such that the first and second hoop portions form a single plane, and in a second, collapsed position the first hoop portion and the second hoop portion are pivoted upwards or downwards so that the first hoop portion is immediately adjacent to the second hoop portion; and
wherein the yoke comprises a main body portion and a slide lock, wherein the slide lock is slidable with respect to the main body portion, such that when the slide lock is in a first position, the first hoop arm and the second hoop arm are in the first, open position and when the slide lock is in a second position, the first hoop arm and the second hoop arm are in a second, collapsed position.

2. The folding landing net of claim 1, further comprising a handle, wherein the handle is inserted into an opening defined by the yoke.

3. The folding landing net of claim 1, wherein the first position is a locked position and the second position is an unlocked position.

4. The folding landing net of claim 1, wherein the main body portion includes at least one pivot pin channel configured to receive at least one pivot pin engaged with the first hoop portion and the second hoop portion, wherein in the first, open position, the at least one pivot pin is received within the at least one pivot pin channel and in a second, collapsed position, the at least one pivot pin is not engaged with the at least one pivot pin channel.

5. The folding landing net of claim 1, wherein the slide lock includes a channel sized and shaped to receive a channel fastener, wherein the channel fastener extends through an opening defined by the main body portion to slidably couple the slide lock to the main body portion.

6. The folding landing net of claim 1, wherein at least one of the main body portion and the slide lock contains a magnet that is attracted to the other of the main body portion and the slide lock.

7. The folding landing net of claim 6, wherein the main body portion comprises a main body portion magnet and the slide lock comprises a slide lock magnet, and wherein the main body portion magnet and the slide lock magnet are attracted to one another.

8. The folding landing net of claim 1, wherein the yoke comprises a first hoop arm defining a first hoop opening and a second hoop arm defining a second hoop opening, wherein the first hoop portion is received within the first hoop opening and the second hoop portion is received within the second hoop opening.

9. The folding landing net of claim 8, wherein the first hoop arm and the second hoop arm are pivotable with respect to the main body portion via at least one pivot pin.

10. The folding landing net of claim 1, wherein the main body portion includes a locking mechanism configured to lock the slide lock in place.

11. A net comprising:
a yoke comprising a main body portion and a slide lock, wherein the slide lock is movable with respect to the main body portion; and
a collapsible hoop configured to collapse in response to movement of the slide lock in a first direction and expand in response to movement of the slide lock in a second direction.

12. The net of claim 11, further comprising a handle, wherein the handle is inserted into an opening defined by the yoke.

13. The net of claim 11, wherein the collapsible hoop comprises a first hoop portion and a second hoop portion, the first hoop portion and the second hoop portion having a proximal end nearest the yoke and a distal end opposing the proximal end.

14. The net of claim 13, wherein the yoke comprises a first hoop arm coupled to the proximal end of the first hoop portion and a second hoop arm coupled to the proximal end of the second hoop portion.

15. The net of claim 14, wherein the collapsible hoop further comprises a first pivot arm coupled to the distal end of the first hoop portion and a second pivot arm coupled to the distal end of the second hoop portion.

16. The net of claim 11, wherein the slide lock includes a channel sized and shaped to receive a channel fastener, wherein the channel fastener extends through an opening defined by the main body portion to couple the slide lock to the main body portion.

17. The net of claim 11, wherein at least one of the main body portion and the slide lock includes a magnet that is attracted to the other of the main body portion and the slide lock.

18. The net of claim 17, wherein the main body portion comprises a main body portion magnet and the slide lock comprises a slide lock magnet, and wherein the main body portion magnet and the slide lock magnet are attracted to one another.

19. The net of claim 14, wherein the main body portion defines one or more pivot pin channels configured to receive one or more pivot pins engaged with at least one of the first hoop arm and the second hoop arm, wherein when the hoop is in an open position, the one or more pivot pins are received within the one or more pivot pin channels and when the hoop is in a collapsed position, the one or more pivot pins are not engaged with the one or more pivot pin channels.

20. The net of claim 11, wherein the main body portion includes a locking mechanism configured to lock the slide lock in place.
